(19) United States
(12) Patent Application Publication
(10) Pub. No.: US 2008/0184872 A1
(43) Pub. Date: Aug. 7, 2008

(54) Microtonal tuner for a musical instrument using a digital interface

(75) Inventors: Aaron Andrew Hunt, Charleston, IL (US); Jordan Dimitrov Petkov, Varna (BG)

Correspondence Address: ERIC R. WALDKOETTER, 2805 WIDAMAN STREET, WINONA LAKE, IN, 46590-1921, US

(73) Assignee: Aaron Andrew Hunt, Charleston, IL (US)

(21) Appl. No.: 11/824,243

(22) Filed: Jun. 29, 2007

Related U.S. Application Data
(60) Provisional application No. 60/817,946, filed on Jun. 30, 2006.

(51) Int. Cl. G10H 7/00

(52) U.S. Cl. 84/645

(57) ABSTRACT

A microtonal tuner permits a musician such as an electronic keyboard player using a fixed pitch instrument with a digital interface, to enhance performance expression by producing tones perceptible to humans that vary in discrete values from a twelve tone equal tempered octave. The microtonal tuner uses a digital interface such as a musical instrument digital interface (MIDI) and comprises a digital input, a digital message analyzer, a controller, a user input, a user output, a tuning program containing tuning data to create a modified digital message and a digital channel to output the modified digital message to produce a microtonal output. The microtonal output can be any number of notes per octave including tunings such as ¼ Comma Meantone, 19 tone equal temperament, 31 tone equal temperament, Harry Partch's 43-tone tuning, and, 205 tone equal temperament.

### RELATED APPLICATION

This application claims priority to U.S. Provisional Patent Application No. 60/817,946 filed Jun. 30, 2006.

### FIELD OF THE INVENTION

This disclosure relates to musical instruments using a digital interface and more specifically to electrical musical tone generation involving note sequence and transposition.

### BACKGROUND OF THE INVENTION

A transposition is the moving of a musical tone from one frequency to another, and minute transpositions are called microtonal. A succession of adjacent microtonal transpositions is called a glissando, and instruments capable of such glissandi are said to have flexible microtonal intonation. The human voice is an example of such an instrument.

Musical harmony is based on the principle of harmonic intervals, or tones occurring simultaneously, which may be represented as a ratio between two frequencies. In music theory, some harmonic intervals are described as pleasant, giving an impression of correctness, coherence or consonance, and others are described as unpleasant, giving an impression of incorrectness, incoherence or dissonance. Psychoacoustic research has found that harmonic intervals are perceived as complex structures by human ears, such that additional frequencies called combination tones are perceived when a given harmonic interval is sounding. The additional tones may be heard at frequencies in specific relationship to the frequencies present in the given harmonic interval. The strongest of these is a so-called Difference Tone (DT) which may be heard at a frequency equal to the difference between the frequencies of the two tones. The flexible microtonal intonation of the human voice allows these complex interval structures to sound correct, coherent, pleasant and consonant.

Fixed pitch instruments such as keyboards were configured to reproduce the concords produced by the flexible microtonal intonation of the human voice within a limited range of transpositions that were considered pleasant sounding, resulting in the twelve key per octave keyboard beginning around 1300 B.C.E. During the renaissance, alternative keyboards were constructed to expand the range of microtonal transpositions that included fourteen key, seventeen key, and thirty-six key per octave keyboards, but the twelve key per octave keyboard remained the dominant keyboard configuration. By the mid-eighteenth century, transposition of the twelve key per octave keyboard was expanded by changing keyboard tuning, which are known as temperaments. Although these keyboard tuning variations allowed a wider range of transposition, uniform purity of microtonal intonation was sacrificed. By the end of the nineteenth century, the use of various temperaments subsided and a tuning known as a twelve tone equal temperament (12ET) became the new popular standard. All interval structures in 12ET are mildly dissonant. In comparison with the flexible microtonal human voice, the fixed structures of 12ET can easily sound incorrect and unpleasant.

In the Twentieth Century, the introduction of electronic instruments created the opportunity for the production of nearly unlimited microtonal transpositions; however, the electronic instruments were expensive, complex, and typically required extension knowledge to program and operate. By 1970 electronic instruments became popular because these instruments were relatively inexpensive and easy to operate. In the early 1980s, a standard digital interface known as Musical Instrument Digital Interface (MIDI) quickly became the most widely used digital interface for electronic musical instruments throughout the world. Although MIDI compatible instruments and accessories have many forms in addition to keyboards, the MIDI data transmission protocol assumes a pitch organization of twelve tones per octave, tuned by default as 12ET. A description of one capability of the general MIDI standard is a Pitch Bend digital message.

A Pitch Bend digital message is a MIDI feature that permits a musician to vary the pitch of the notes being played by typically a whole step up or down from the pitch of the keys played. The musician typically operates the Pitch Bend feature using an analog actuator such as a wheel, joystick, or ribbon control strip. Although Pitch Bend permits a musician to vary the pitch of notes with microtonal transposition in glissando, the Pitch Bend feature does not permit a musician to program a musical instrument to vary individual note pitches without affecting the tuning of other pitches on the same MIDI channel. A keyboard with Pitch Bend capability is shown in Yamaha CBX-K1 MIDI keyboard available from the Yamaha Corporation of America of Buena Park, Calif.

A sequencer is hardware or software tool that records, plays back, and edits MIDI data. Early MIDI sequences were hardware-based, but the term sequencer is now primarily used for software based MIDI sequencers. Some synthesizers and almost all music work stations include a built-in MIDI sequencer. To achieve polyphonic microtonal results using Pitch Bend retuning, multiple tracks are used. An example of a dedicated sequencing software program is Digital Performer available from MOTU, Inc. of Cambridge, Mass.

What is needed is a microtonal tuner that permits a musician, such as an electronic keyboard player, using a fixed pitch instrument with a digital interface, while performing to enhance expression by producing tones perceptible to humans that vary in discrete values from a twelve tone equal tempered octave, allowing unlimited microtonal transposition and the production of pleasant and coherent interval structures.

### SUMMARY OF THE INVENTION

A microtonal tuner permits a musician, such as an electronic keyboard player using fixed pitch instrument with a digital interface, to enhance performance expression by producing tones perceptible to humans that vary in discrete values from a twelve tone equal tempered octave. The microtonal tuner uses a digital interface, such as a musical instrument digital interface (MIDI), and comprises a digital input, a digital message analyzer, a logic controller, a user input, a user output, a tuning program containing tuning data to create a modified digital message and a digital channel to output the modified digital message to produce a microtonal output. The microtonal output can accommodate any number of notes per octave including tunings such as ¼ Comma Meantone, 19 tone equal temperament, 31 tone equal temperament, Harry Partch's 43-tone tuning, and, 205 tone equal temperament.

A method for microtonal tuning a musical instrument using a digital interface, in another version of the invention, comprises programming a tuning program with microtonal tuning instructions; receiving a digital message for a music instruction; analyzing the digital message to determine the music instruction status; identifying a note-on music instruction status; processing the note-on music instruction status through the tuning program; generating a modified note-on digital message for a microtonal note that varies in a discrete value from a standard twelve equal temperament tuning octave; selecting a digital output channel for the microtonal note digital message; and, outputting the modified note-on digital message on the available digital channel to produce a microtonal note that varies in a discrete value from a standard twelve equal temperament tuning octave.

### BRIEF DESCRIPTION OF THE DRAWINGS

FIG. 1 shows a microtonal tuner with a keyboard having an internal synthesizer embodiment.

FIG. 2 shows a microtonal tuner with a keyboard controller and a keyboard synthesizer embodiment.

FIG. 3 shows a microtonal tuner with keyboard controller and an external tone module or sampler embodiment.

FIG. 4 shows a microtonal tuner with two keyboard controllers and an external tone module or sampler embodiment.

FIG. 5 shows a microtonal tuner with two keyboard controllers and an external tone module or sampler, and a computer with a Musical Instrument Digital Interface (MIDI) embodiment.

FIG. 6 shows a microtonal tuner front panel embodiment.

FIG. 7a shows a microtonal tuner rack-mount front panel embodiment.

FIG. 7b shows a microtonal tuner rack-mount rear panel embodiment.

FIG. 8 shows a microtonal tuner integrated into a keyboard controller embodiment.

FIG. 9 shows a microtonal tuner integrated into a keyboard controller embodiment.

FIG. 10 shows a block diagram of a microtonal tuner embodiment.

FIG. 11 shows a flowchart of incoming MIDI instruction routing embodiment.

FIG. 12 shows a flow chart of MIDI Note On instructions embodiment.

FIG. 13 shows a flow chart of MIDI Note Off instructions embodiment.

FIG. 14 shows a flow chart of MIDI CC instructions embodiment.

FIG. 15 shows a flow chart of MIDI system exclusive instructions embodiment.

FIG. 16 shows a flow chart of MIDI Sustain Off instruction embodiment.

FIG. 17 shows a flow chart of MIDI selection of a preset instruction embodiment.

FIG. 18 shows a flow chart of MIDI selection of a bank and patch instruction embodiment.

FIG. 19 shows a flow chart of MIDI receive tuning data instruction embodiment.

FIG. 20 shows a flow chart of MIDI send tuning data instruction embodiment.

FIG. 21a shows a major third harmonic interval in traditional music notation.

FIG. 21b shows a root octave transposition in traditional music notation.

FIG. 21c shows a difference tone resulting from a major third interval tuned in equal temperament.

FIG. 21d shows a difference tone resulting from a major third interval tuned in just intonation.

FIG. 22a shows a signal diagram of a one cycle wavelength incidences for two waves in frequency relationship of 4:5.

FIG. 22b shows a signal diagram of three cycles of wavelength incidences for three waves in frequency relationships of 1:4:5.

### DETAILED DESCRIPTION

Fixed pitch musical instruments having digital interfaces are numerous and include keyboard synthesizers and keyboard controllers. In addition to musical instruments having digital interfaces, there are numerous instrument accessories that also have digital interfaces including tone modules, tone samplers, computers, and the like.

Musical instruments having a digital interface generally operate by a musician actuating a musical element that generates an electronic message. A microtonal keyboard controller uses a digital interface, further comprising a keyboard having keys that generate a digital message corresponding to each key that is operated. The electronic message conforms to parameter of a digital interface such as a version of the Musical Instrument Digital Interface (MIDI) that is described in MIDI Medial Adaptation Layer for IEEE-1394 (Nov. 30, 2000). There are currently several specifications of MIDI to include General MIDI Level 1, General MIDI Level 2, and General MIDI lite, and in the future there will likely be more MIDI specifications developed. In addition to current and future versions of MIDI, other digital interfaces for musical instruments that have similar capabilities as MIDI could be used with the microtonal tuner.

Although musical instruments having digital interfaces can permit compatibility among other musical instruments having digital interfaces and accessories, the digital interfaces have tuning limitations. For example assume a keyboard player who wants to perform an expressive improvisation using nineteen equally spaced pitches per octave such as shown in Table 3. Additionally, the player wants to perform music written by the Russian composer Ivan Wyschnegradsky (1893-1979) using thirty-one pitches per octave as shown in Table 4, as well as music written by the American composer Harry Partch (1901-1976) using forty-three unequally spaced pitches per octave as shown in Table 5. None of the desired tunings are unavailable on a standard keyboard. The microtonal tuner 75 allows the player to perform all of this music using a standard electronic keyboard instrument. The player sets up the keyboard and amplification equipment in the usual way, and simply connects a microtonal tuner 75, which contains all of the desired tuning tables in its memory, to the keyboard. Before performing, the desired tuning is simply recalled by the push of a button on the microtonal tuner 75. The player then performs in the usual way on the keyboard, and the microtonal tuner 75 retunes the performance as desired. For each new performance, a different tuning may be used simply by pressing a button to recall the appropriate tuning table on the microtonal tuner 75, allowing the player to easily perform music in a variety of tunings on a single keyboard.

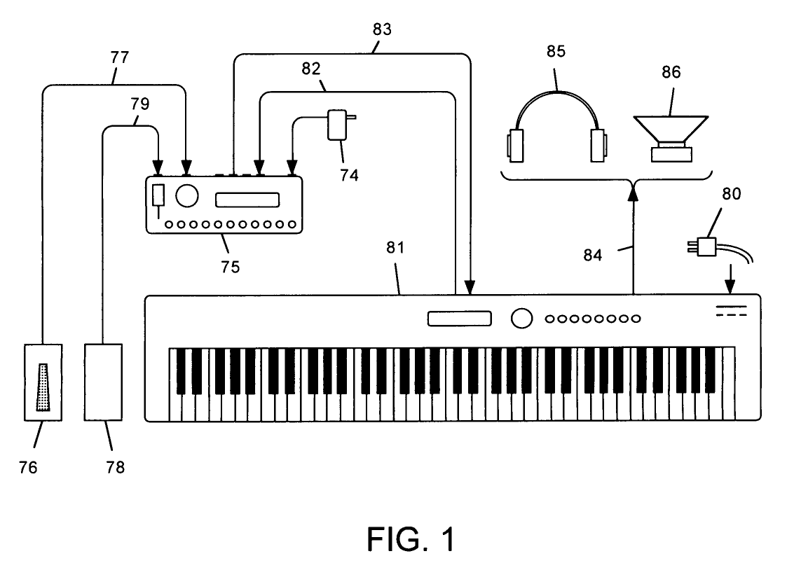

FIG. 1 shows a microtonal tuner 75 with a keyboard synthesizer 81 embodiment. The keyboard synthesizer 81 can be enhanced with a microtonal tuner 75 to allow the musician to produce discrete values from a standard twelve equal temperament tuning octave in a live performance environment, where an AC-DC external transformer 74 is connected to a DC power input 63, a sustain pedal 76 is connected 77 to the sustain pedal input jack 56, and a volume pedal 78 is connected 79 to the volume pedal input jack 58, of a microtonal tuner 75, and an external AC power 80 is supplied to a keyboard synthesizer 81 connected 82 to a MIDI IN port 62 of a microtonal tuner 75, and connected 83 to a MIDI OUT port 60 of a microtonal tuner 75, and an audio signal 84 is sent out from the keyboard synthesizer 81 to headphones 85 or an amplifier and speakers 86.

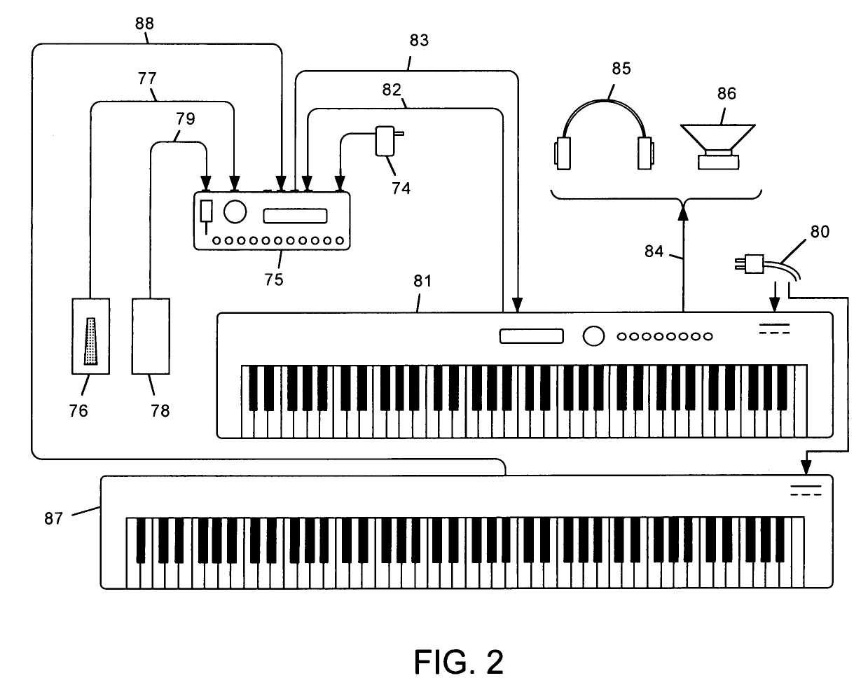

FIG. 2 shows a microtonal tuner 75 with a keyboard controller 87 and a keyboard synthesizer 81 embodiment. A self-contained microtonal tuner 75 may be used in a live performance environment with two keyboards where an arrangement as shown in (FIG. 1) includes the addition of a keyboard controller 87 which receives external AC power 80 and is connected 88 to a MIDI IN port 61 of a microtonal tuner 75.

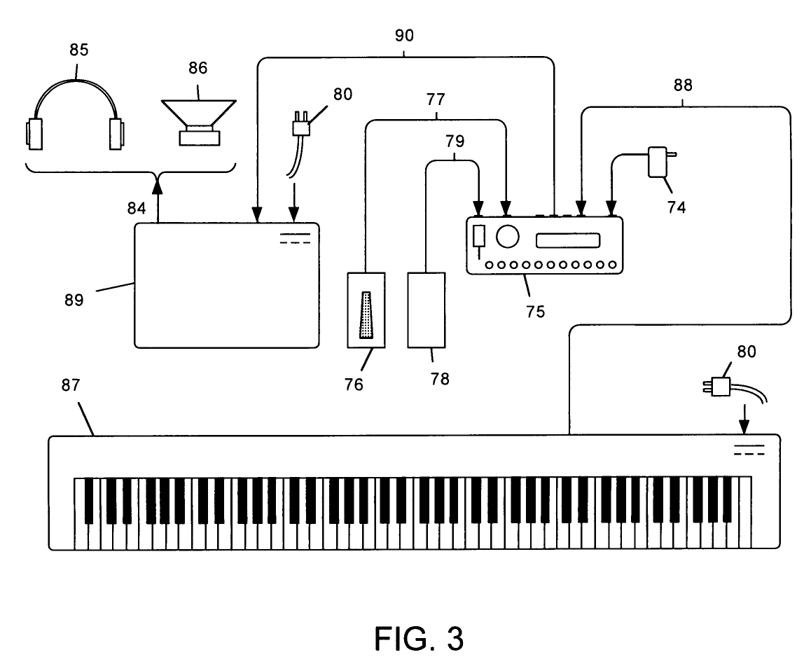

FIG. 3 shows a microtonal tuner 75 with keyboard controller 87 and an external tone module 89 embodiment. A self-contained microtonal tuner 75 may be used in a live performance environment with a keyboard controller 87 and a tone module 89, where an AC-DC external transformer 74 is connected to a DC power input 63, a sustain pedal 76 is connected 77 to the sustain pedal input jack 56, and a volume pedal 78 is connected 79 to the volume pedal input jack 58, of a microtonal tuner 75, and an external AC power 80 is supplied to a keyboard controller 87 properly connected 88 to a MIDI IN port 62 of a microtonal tuner 75, and a tone module or sampler 89 receiving external AC power 80 is connected 90 to a MIDI OUT port 60 of a microtonal tuner 75, and an audio signal 84 is sent out from the tone module or sampler 89 to headphones 85 or an amplifier and speakers 86.

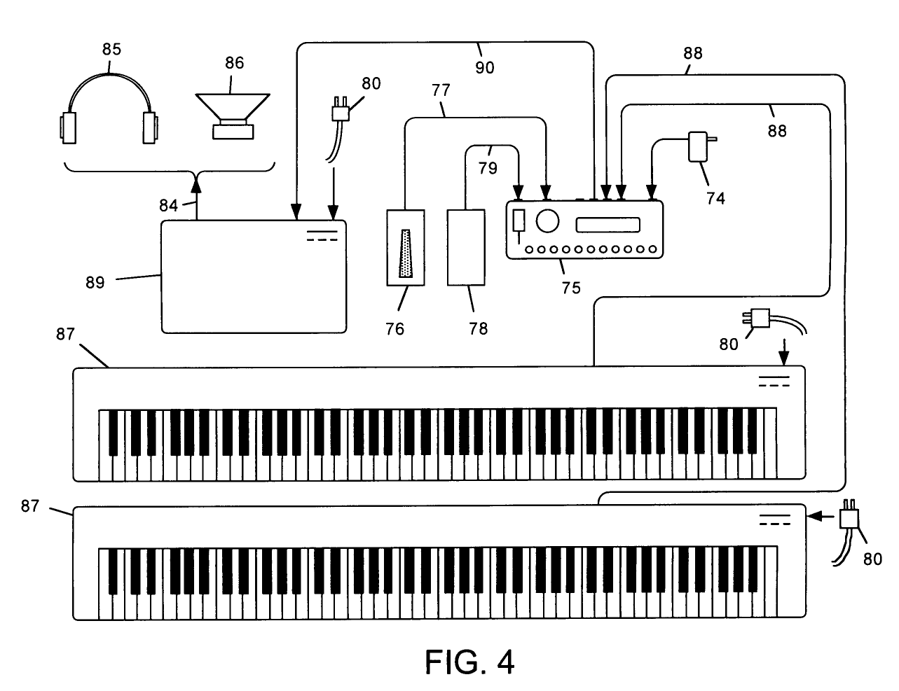

FIG. 4 shows a microtonal tuner 75 with two keyboard controllers 87 and an external tone module 89 embodiment. A self-contained microtonal tuner 75 may be used in a live performance situation with two keyboard controllers 87 and one tone module 89 where an arrangement as shown in FIG. 3 includes the addition of a second keyboard controller 87 which receives external AC power 80 and is properly connected 88 to a MIDI IN port 61 of a microtonal tuner 75.

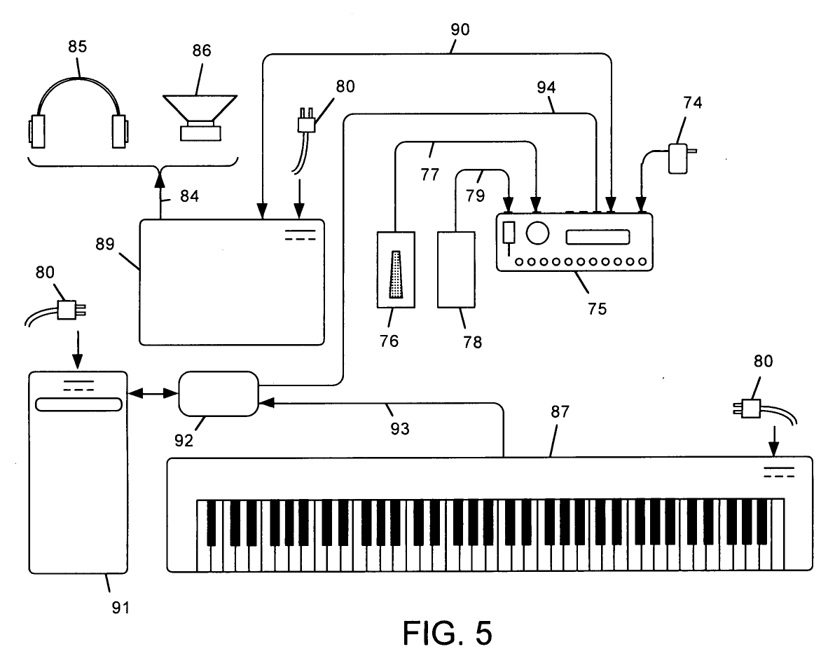

FIG. 5 shows a microtonal tuner 75 with two keyboard controllers 87 and an external tone module 89, and a computer 91 with a MIDI 92 embodiment. A self-contained microtonal tuner 75 may be used in a studio sequencing situation with a keyboard controller 87, a tone module 89, and a computer 91 where an arrangement as shown in FIG. 4 includes the addition of a computer 91 which receives external AC power 80 and is connected to a MIDI interface 92 which is connected 93 to a keyboard controller 87 and connected 94 to a MIDI IN port 59 of a microtonal tuner 75.

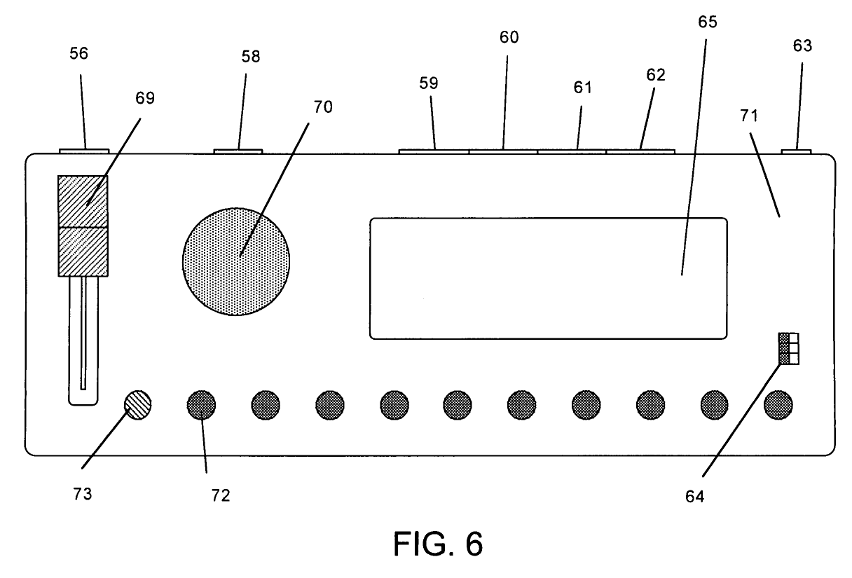

FIG. 6 shows a microtonal tuner 75 front panel embodiment. A design for a portable self-contained microtonal tuner includes a variety of input and output jacks and user interface components. A quarter-inch volume pedal input jack 56 accepts a ring-tip-sleeve quarter-inch plug connected to an external potentiometer such as is found in a typical volume pedal. A rotary encoder 57 allows the user to select or change stored values by turning or pushing. A quarter-inch sustain pedal input jack 58 accepts a tip-sleeve quarter-inch plug connected to an external switch such as is found in a typical damper pedal. A five-pin DIN receptacle MIDI THRU port 59 accepts a five-pin DIN plug connected to an external MIDI device to receive unaltered output. A five-pin DIN receptacle MIDI OUT port 60 accepts a five-pin DIN plug connected to an external MIDI device to receive retuned output. Two five-pin DIN receptacles MIDI IN ports 61, 62 accept five-pin DIN plugs connected to external MIDI devices to receive MIDI input. A DC power input coaxial receptacle 63 accepts a coaxial plug connected to a transformer supplying adequate DC power. Option switches 64 allow the user to select various settings. An LCD display 65 shows settings, data, etc. to the user. An enclosure 66 contains the apparatus. Momentary buttons 67 allow the user to select or change output parameters. A slide potentiometer 68 allows the user to alter an output parameter.

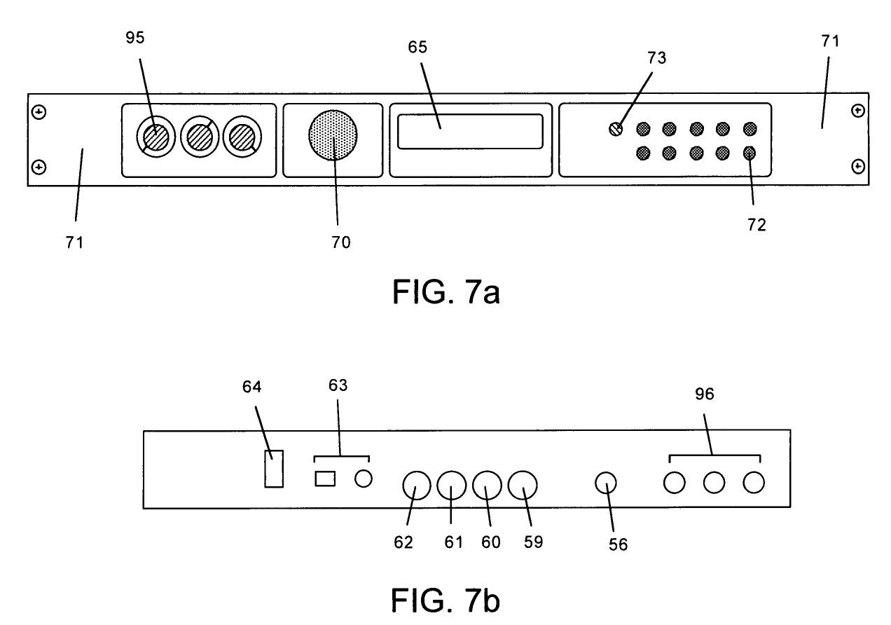

FIG. 7a shows a rack-mount microtonal tuner 75 front panel embodiment, and FIG. 7b shows a rack-mount microtonal tuner 75 rear panel embodiment. Some users prefer rack-mount devices; to fulfill such a need, an external design for a rack-mount microtonal tuner 75 shows an arrangement of various user interface components, including replacement of slide potentiometer 56 control knob 70 with multiple control knobs 95, including increased logo space 71. Inputs and outputs may also be varied with the replacement of a volume pedal input jack 58 with multiple volume pedal input jacks 96.

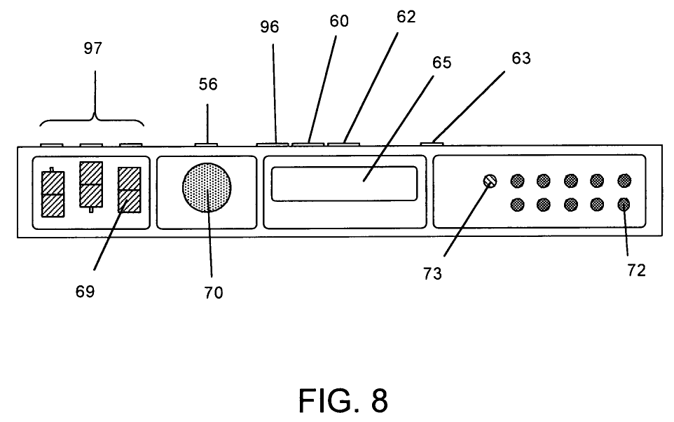

FIG. 8 shows a microtonal tuner 75 integrated into a keyboard synthesizer 81 embodiment. Many users desire a keyboard synthesizer 81 having internal retuning capabilities. To fulfill such a need, a microtonal tuner 75 for use within a larger device may be provided to carry out the logical method provided in (FIGS. 1-10). An external design for a microtonal tuner 75 for use within a larger device such as a keyboard controller 87 is similar to (FIG. 7a,7b), where multiple control knobs 95 are replaced by slider controls 69, one MIDI IN port 62 is included, and a MIDI THRU port 59 is replaced by a MIDI OUT UNTUNED port 97.

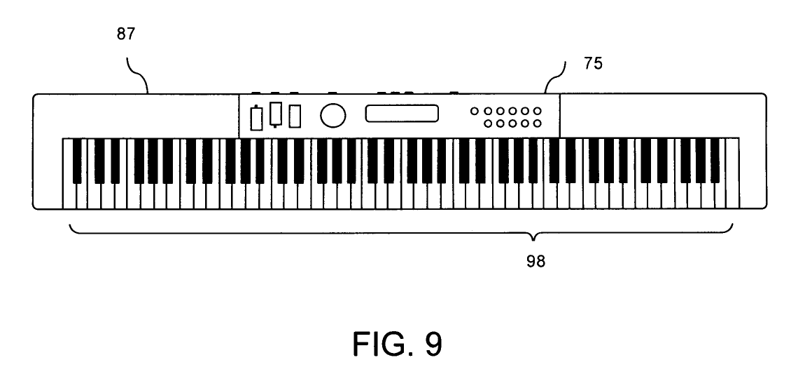

FIG. 9 shows a microtonal tuner 75 integrated into a keyboard controller 87 or keyboard synthesizer 81 embodiment. Some users desire a conventional keyboard controller 87 or keyboard synthesizer 81 having internal retuning capabilities. To fulfill such a desire, a conventional keyboard controller 87 or keyboard synthesizer 81 containing a microtonal tuner 75 may be designed, where a keyboard controller 87 or keyboard synthesizer 81 having a standard key array 98 is internally connected to a microtonal tuner 75. The standard key array 98 may also be replaced with a non-standard key array.

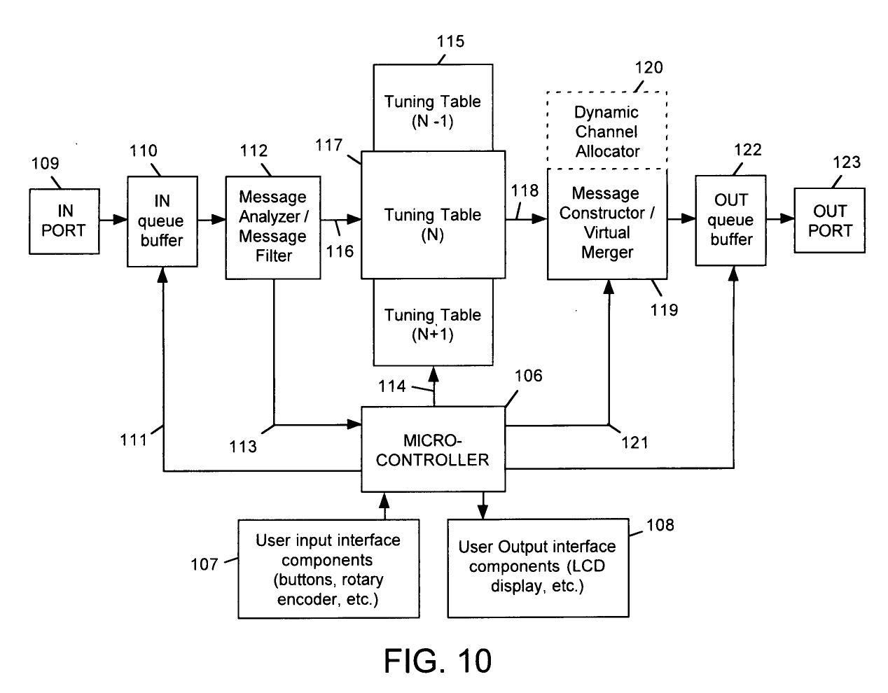

FIG. 10 shows a block diagram of a microtonal tuner 75 embodiment. A microtonal tuner 75 for a musical instrument using a digital interface comprises a digital input 109, a digital input queue buffer 110, a digital message analyzer 112, a logic controller 106, a user input 107, a user output 108, a tuning program 115, a digital message constructor and virtual merger 119, a digital output queue buffer 122, and a digital output 123. Some embodiments of the microtonal tuner 75 can include a dynamic channel allocator 120. The digital input 109 is configured to receive a standard digital message using a standard digital connector. In some versions of the invention, the digital input 109 is MIDI compatible. The digital message analyzer 112 is coupled to the digital input 109 through the digital input queue buffer 110 to identify a digital message type. In some versions of the invention, the digital message type is MIDI compatible. The logic controller 106 is coupled to the digital input queue buffer 110. The logic controller 106 can be a logic gate array, a microcontroller or any variety of circuitry intended to perform similar functions. The user input 107 is coupled to the logic controller 106 for modifying user controlled parameters. A user interface component can be a button 72 or a rotary encoder 70, or any other variety of control apparatus suitable for user input control. The user output 108 is coupled to the logic controller 106 for communicating microtonal information such as various currently selected parameters and musical data. A user output can be an LCD display 65, TFT display, touch panel display or any variety of apparatus suitable for displaying user output information.

One version of the tuning program 115 contains tuning instructions, such as tuning data such as shown in Tables 1-7, or a tuning algorithm such as shown in Formula 1, and is coupled to the logic controller 106 to create a modified digital message for producing a microtonal output in real-time that varies in discrete values from a twelve tone equal tempered octave. The tuning data comprises note number and Pitch Bend data such as shown in Tables 1-7. In some versions of the tuning program 115, the tuning program can be preprogrammed with a program such as: ¼ Comma Meantone shown in Table 2, 19 tone equal temperament shown in Table 3, 31 tone equal temperament shown in Table 4, and, Harry Partch's 43-Tone Tuning shown in Table 5. The modified digital message comprises modified digital messages producing multiple microtonal outputs and each microtonal output can vary independently in pitch from each other microtonal output. Another version of the tuning program 115 contains a tuning algorithm, such as shown in Formula 1, and is coupled to the controller to create a modified digital message for producing a microtonal output in real-time that varies in discrete values from a twelve tone equal tempered octave.

The digital output 123 outputs the modified digital message for producing a microtonal output. In some versions of the invention, the digital output is compatible with a musical instrument digital interface (MIDI). In some versions of the microtonal tuner the modified digital message includes multiple modified digital messages producing multiple microtonal outputs and each microtonal output varies independently in pitch from each other microtonal output.

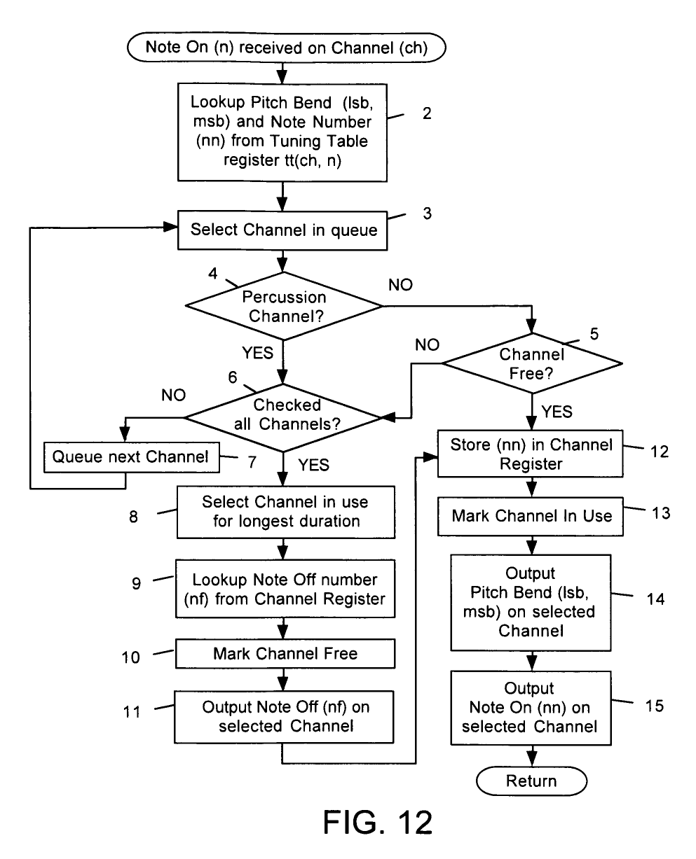

The dynamic channel allocator 120 (FIG. 12) dynamically routes the modified digital message to an available digital output for producing a microtonal output.

Some versions of the microtonal tuner 75 can include a tone module 89 for receiving the modified digital message from the digital output 123 to produce an audio output 84 during musical instrument performance. The digital output can be a single digital channel. Some versions of the microtonal tuner 75 can include an analog to digital converter for converting an analog frequency to a note digital message.

The logic controller 106 receives input from user interface input components 107 such as buttons and a rotary encoder, etc., and transmits output to user interface output components 108 such as an LCD, etc. A digital input 109 allows digital messages to be received from external digital hardware and placed in a digital input queue buffer 110, which is managed 111 concurrently with a digital output queue buffer 122 by the logic controller 106. Incoming digital data is analyzed and filtered 112 and nominal messages are handled by the logic controller 106. A tuning program 117 is selected 114 by the logic controller 106 from all available tuning programs 115 through user interaction with user interface input components 107 or by messages received from the digital input 109 from external digital devices. Digital input messages 116 continue from the digital message analyzer/filter 112 to the tuning program 117 from which tuning data or tuning algorithm are retrieved and sent 118 to the digital message constructor/virtual merger 119 which may route the data using a dynamic channel allocator 120, while also merging incoming digital messages 121 which have been passed from the digital input 109 through the digital input queue buffer 110 to the digital message analyzer/filter 112 to the logic controller 106. The resulting messages are prepared in the digital output queue buffer 122, managed by the logic controller 106 for output at the digital output 123.

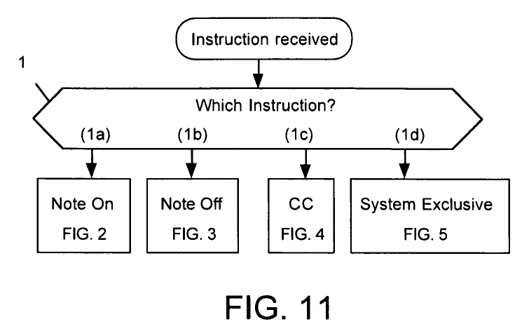

FIG. 11 shows a flowchart of incoming MIDI instruction routing embodiment. MIDI instructions are received and identified 1 as Note On (1a), Note Off (1b), CC (1c), or System Exclusive (1d). Although FIGS. 11-20 use MIDI terminology any variety of digital message format could be used. A method for microtonal tuning a musical instrument using a digital interface comprises a number of elements that can be performed or stored on a computer readable storage medium that when executed by a computer causes the computer to perform microtonal tuning of a musical instrument. The method for microtonal tuning a musical instrument comprises programming a tuning table, analyzing a digital message, identifying a note-on musical instruction, processing the note-on musical instruction, selecting a digital output, and outputting a modified note-on digital message.

The version of the tuning program 117 containing tuning data can be programmed with microtonal tuning instructions in a variety of ways. The tuning data comprises a tuning table, note number, and pitch bend data. The version of the tuning program 117 operates as follows. The digital message is received for a musical instruction. The digital message is analyzed to determine the music instruction status. A note-on music instruction status is identified. The music instruction status is processed through the tuning program. A modified note-on digital message is generated for a microtonal note that varies in a discrete value from a standard twelve tone equal temperament tuning octave. A digital output channel is selected for the microtonal note digital message. The microtonal note digital message is outputted on the available digital channel to produce a microtonal note that varies in a discrete value from a standard twelve equal temperament tuning octave.

Some versions of the invention can further comprise receiving the modified note-on digital message on the available digital channel by a synthesizer to produce an audio output during musical instrument performance.

Some versions of the invention can further comprise dynamic channel allocation of a microtonal message for a musical instrument using a digital interface. An available digital output channel is dynamically identified. A digital output channel is selected for the note-on digital message. The digital microtonal note message is sent on the available digital channel.

FIG. 12 shows a flow chart of MIDI Note On instructions embodiment using a dynamic channel allocator 120. A received Note On Instruction (1a) initiates a routine in which the Note On (n) and Channel (ch) direct a pointer 2 to lookup Pitch Bend (lsb, msb) and a Note Number (nn) from a Tuning Table register tt(ch,n). A MIDI Channel 3 in a queue is selected and identified 4 as a Percussion or non-Percussion Channel. If the Channel 3 is not a Percussion Channel, it is identified 5 as Free or not Free. If the Channel 3 is not Free, or the Channel 3 is a Percussion Channel, it is then determined 6 if all Channels have been checked. If all Channels have not been checked, the next Channel is queued 7 and the checking routine repeats. If the Channel 3 is Free 5, then the Note Number (nn) is stored in a Channel Register 12, the Channel 3 is marked In Use 13, MIDI Pitch Bend (lsb, msb) is output 14 on selected Channel 3, and MIDI Note On (nn) is output 15 on selected Channel 3. If all Channels have been checked 6, then the Channel in use for the longest duration 8 is selected, a Note Off number (nf) is found in the corresponding Channel Register 9, the Channel 8 is marked Free 10, MIDI Note Off (nf) is sent on the selected Channel 8, the Note Number (nn) is stored in a Channel Register 12, the Channel 8 is marked In Use 13, MIDI Pitch Bend (lsb, msb) is output 14 on selected Channel 8, and MIDI Note On (nn) is output 15 on selected Channel 8.

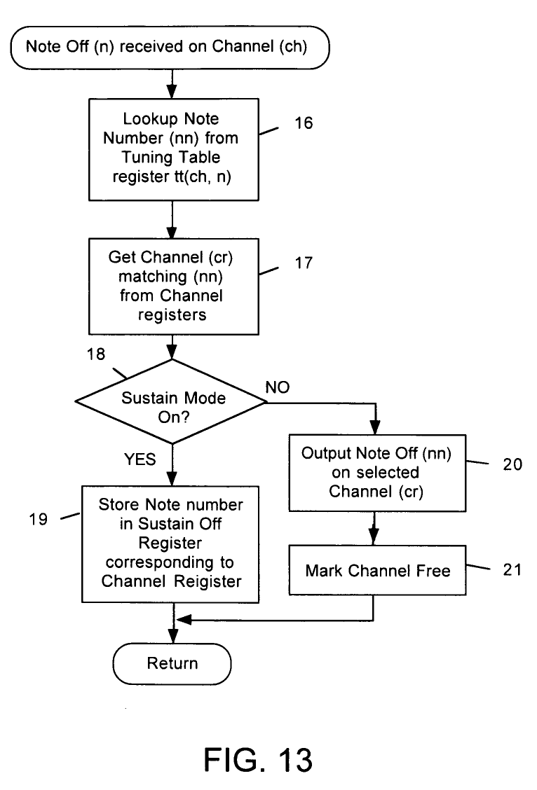

FIG. 13 shows a flow chart of MIDI Note Off instructions embodiment. A received Note Off Instruction (1b) initiates a routine in which the Note Off (n) and Channel (ch) data bytes direct a pointer 16 to lookup a Note Number (nn) from a Tuning Table register tt(ch,n). A Channel (cr) is found from the Channel Register 17 corresponding to the Note Number (nn). If Sustain Mode 18 is Off, a MIDI Note Off (nn) is sent 20 on the selected Channel (cr), and the Channel (cr) is marked Free 21. If Sustain Mode 18 is On, The Note Number (nn) is stored in a Sustain Off Register 19 corresponding to the Channel (cr) Register 17.

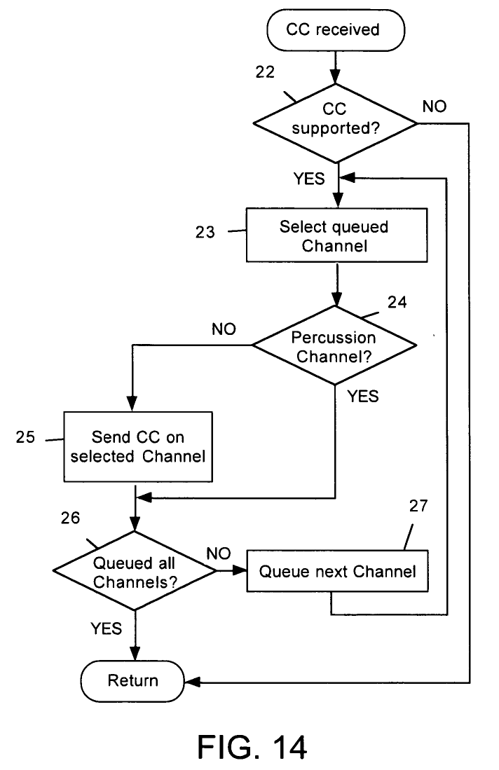

FIG. 14 shows a flow chart of MIDI CC instructions embodiment. A received CC Instruction (1c) initiates a routine in which the CC type is first checked as supported or unsupported 22. If the CC is supported, a Channel 23 in a queue is selected, and determined to be a Percussion or non-Percussion Channel 24. If the Channel 23 is a Percussion Channel and all Channels have not been queued 26, the next Channel is queued 27 and the checking routine repeats. If the Channel 23 is not a Percussion Channel, MIDI CC 25 is sent on the selected Channel 23, and if all Channels have not been queued 26 then the next Channel is queued 27 and the routine repeats.

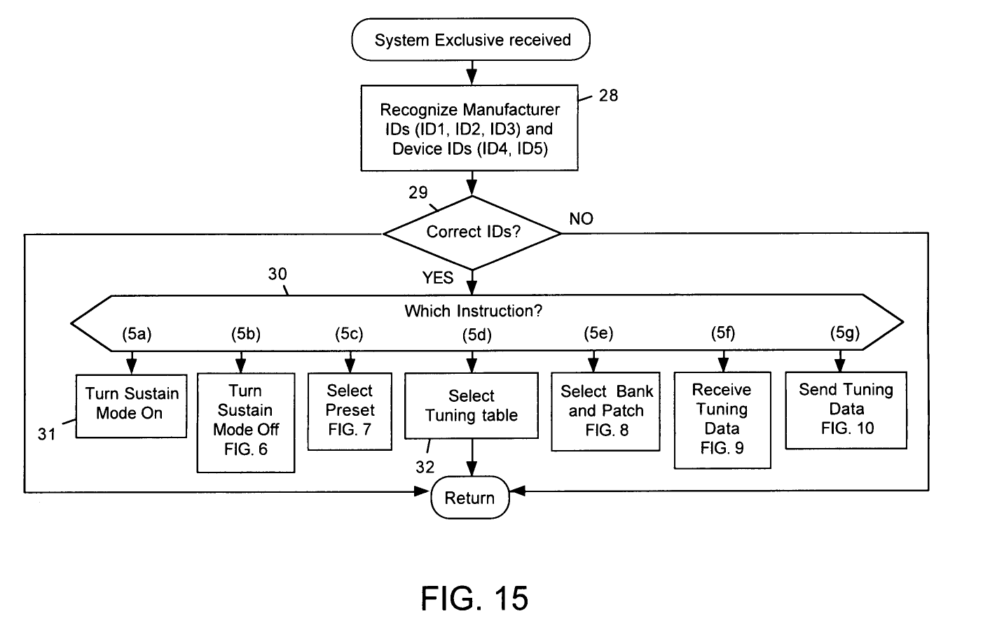

FIG. 15 shows a flow chart of MIDI system exclusive instructions embodiment. A received System Exclusive Instruction (1d) initiates a routine in which the data bytes are analyzed 28 to determine if the instruction is intended for the apparatus 29, and if so, the instruction is identified 30 as Turn Sustain Mode On (5a) which engages the Sustain Mode 31 which may also be engaged by means of a simple switch or a standard MIDI Sustain On message, Turn Sustain Mode Off (5b), Select Preset (5c), Select Tuning Table (5d) which moves a memory pointer 32 to Tuning Table (tt) and which may also be activated by means of a standard MIDI Bank Select message, Select Bank and Patch (5e), Receive Tuning Data (5f), or Send Tuning Data (5g).

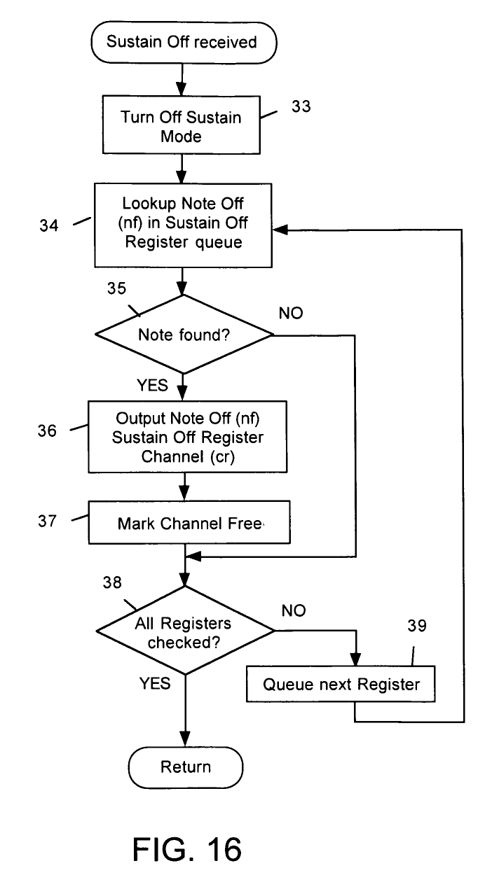

FIG. 16 shows a flow chart of MIDI Sustain Off instruction embodiment. A received System Exclusive Instruction (1b) identified as Sustain Mode Off (5b) initiates a routine, which may also be engaged by means of a switch or a standard MIDI Sustain Off message, in which the Sustain Mode is turned OFF 33, a Note Number (nf) is looked up from a Sustain Off Register queue 34, and if a Note Number (nf) is not found 35, and all Registers have not been checked 38, then the next Sustain Register is queued 39, and the routine repeats. If a Note Number (nf) is found, then MIDI Note Off (nf) is sent 36 on Channel (cr) corresponding to Sustain Register 34, the Channel (cr) is marked as Free 37, and if all Registers have not been checked 38 then the next Sustain Register is queued 39 and the routine repeats.

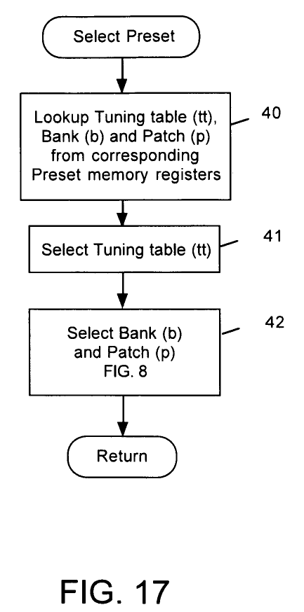

FIG. 17 shows a flow chart of MIDI selection of a preset instruction embodiment. A received System Exclusive Instruction (1b) identified as Select Preset (5c) initiates a routine (FIG. 7), which may also be engaged by means of a switch or a standard MIDI Bank Select message, in which memory pointers 41, 42 are moved to Tuning Table (tt), Bank (b), and Patch (p) corresponding to a Preset memory register 40.

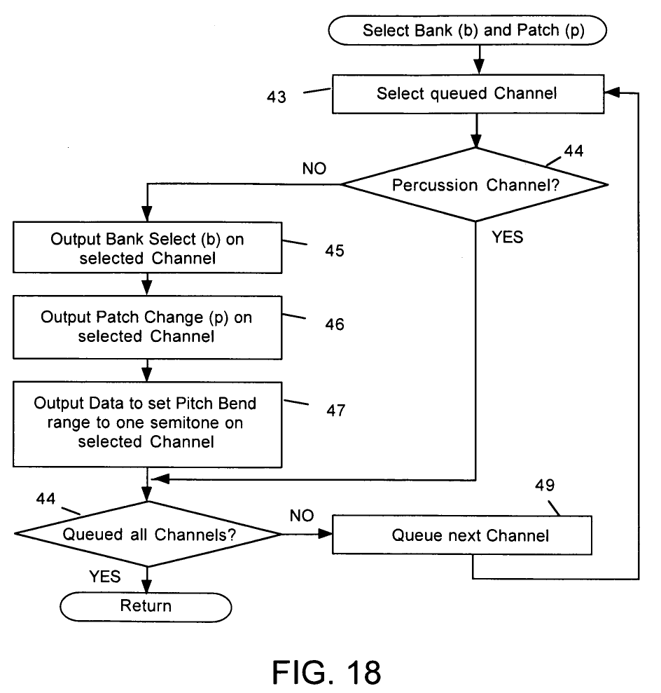

FIG. 18 shows a flow chart of MIDI selection of a bank and patch instruction embodiment. A received System Exclusive Instruction (1b) identified as Select Bank and Patch (5e) initiates a routine, which may also be engaged by means of a switch or a standard MIDI Bank Select message, in which a Channel 43 in a queue is selected, and identified 44 as a Percussion or non-Percussion Channel. If the Channel 43 is a Percussion Channel and all Channels have not been checked 48, then the next Channel 49 is queued and the checking routine is repeated. If the Channel 43 is not a Percussion Channel, MIDI Bank Select (b) is output 45 on the selected Channel 43, MIDI Patch Change (p) is output 46 on the selected Channel 43, MIDI RPNs and Data Increments to set Pitch Bend are output 47 on the selected Channel 43, it is determined if all Channels have been checked 48, and if not, then the next Channel 49 is queued and the checking routine is repeated.

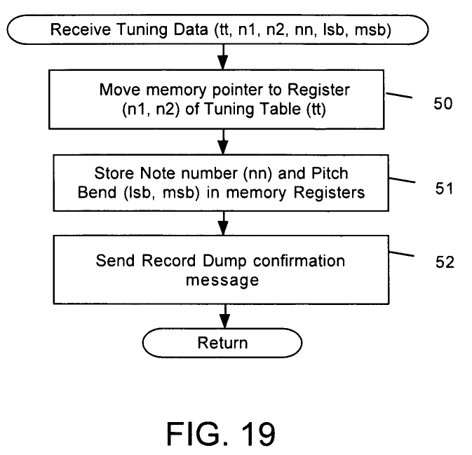

FIG. 19 shows a flow chart of MIDI receive tuning data instruction embodiment. A received System Exclusive Instruction (1b) identified as Receive Tuning Data (5f) initiates a routine, in which a memory pointer is moved 50 to a register (n1, n2) of Tuning Table (tt), a Note Number (nn) and Pitch Bend (lsb, msb) are stored 51 in memory Registers, and a Record Dump confirmation message (start, nn, lsb, msb, stop) is sent 52.

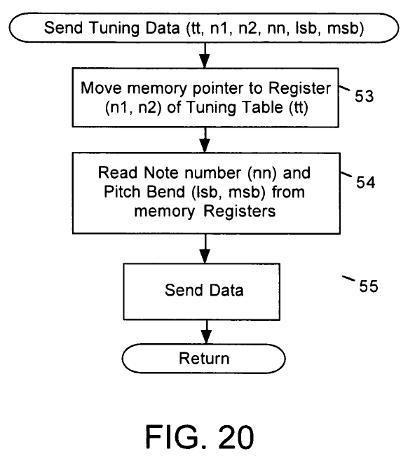

FIG. 20 shows a flow chart of MIDI send tuning data instruction embodiment. A received System Exclusive Instruction (1b) identified as Send Tuning Data (5g) initiates a routine (FIG. 10), in which a memory pointer is moved 53 to a register (n1, n2) of Tuning Table (tt), a Note Number (nn) and Pitch Bend (lsb, msb) are read 54 from memory Registers, and data (start, n1, n2, nn, lsb, msb, stop) is sent 55.

In one embodiment, the tuning program 117 tuning data comprises a tuning table, note number, and pitch bend data. A tuning program 117 may consist of a tuning lookup table or a tuning algorithm. In a tuning lookup table, a value is retrieved from a memory register according to an incoming index number interpreted as a memory pointer. Any values may be stored in a tuning lookup table, and no calculation is necessary. Stored values can be preformatted as digital messages to be sent to a digital musical instrument, such that no conversion function is required.

A plethora of tunings should be preloaded into the microtonal tuner 75 memory for users to explore easily. Users should also be able to program custom tables for any desired tuning. In addition to user input interface components 107, software may be provided for this purpose. Though a tuning program 117 involves mathematics, user retuning interfaces should emphasize simple and intuitive non mathematical methods of retuning such as moving slider controls or selecting a few parameters to retune an array of keys.

Examples of various tuning data are shown as Tables 1-7. At the top of each chart, the name of a tuning is shown. Seven column headings are divided into three groups. The left group of two bold columns shows the enumeration of input data. Two middle columns show mathematical representations of desired pitches. Three bold columns on the right show retuned data to be output. Reading from left to right on a single row, a given pitch (step) for an input MIDI Note (key), is followed by a mathematical representation of a desired pitch (tone), the distance spanned by this tone in 1/1200 octave units from a common zero point (cents), and the retuned MIDI Note (nn), Pitch Bend LSB (lsb) and Pitch Bend MSB (msb) to be output when this (key) is input.

Table 1 below shows standard 12ET tuning; hence, this table represents the standard tuning which may be compared with other example tunings provided here. Tones (tone) are mathematically defined as increasing fractional n/12 roots of 2, and distances (cents) are shown in increasing steps of 100 cents. The input MIDI Note (key) is the same as the output MIDI Note (nn), each Pitch Bend LSB (lsb) is the default value of 64, and each Pitch Bend MSB (msb) is a default value of 0.

TABLE 1
Tuning Data for Standard 12ET Tuning

| Step | Key | Tone | Cents | nn | lsb | msb |
|---|---|---|---|---|---|---|
| 0 | 60 | 2\hat{ }( 0/12) | 0 | 60 | 64 | 0 |
| 1 | 61 | 2\hat{ }( 1/12) | 100 | 61 | 64 | 0 |
| 2 | 62 | 2\hat{ }( 2/12) | 200 | 62 | 64 | 0 |
| 3 | 63 | 2\hat{ }( 3/12) | 300 | 63 | 64 | 0 |
| 4 | 64 | 2\hat{ }( 4/12) | 400 | 64 | 64 | 0 |
| 5 | 65 | 2\hat{ }( 5/12) | 500 | 65 | 64 | 0 |
| 6 | 66 | 2\hat{ }( 6/12) | 600 | 66 | 64 | 0 |
| 7 | 67 | 2\hat{ }( 7/12) | 700 | 67 | 64 | 0 |
| 8 | 68 | 2\hat{ }( 8/12) | 800 | 68 | 64 | 0 |
| 9 | 69 | 2\hat{ }( 9/12) | 900 | 69 | 64 | 0 |
| 10 | 70 | 2\hat{ }( 10/12) | 1000 | 70 | 64 | 0 |
| 11 | 71 | 2\hat{ }( 11/12) | 1100 | 71 | 64 | 0 |
| 12 | 72 | 2\hat{ }( 12/12) | 1200 | 72 | 64 | 0 |

Table 2 below shows the tuning data for ¼ Comma Meantone, the tuning data, which is appropriate for a wide range of Western music written prior to the 18th century. Each input MIDI Note (key) is the same as the output MIDI Note (nn); however, each Pitch Bend LSB (lsb) and Pitch Bend MSB (msb) specifies a pitch unavailable in conventional modern 12ET tuning.

TABLE 2
Tuning Data for ¼ Comma Meantone Tuning

| Step | Key | Tone | Cents | nn | lsb | msb |
|---|---|---|---|---|---|---|
| 0 | 60 | 5\hat{ }(¼)\hat{ }0 | 0 | 60 | 64 | 0 |
| 1 | 61 | ((5\hat{ }(¼))\hat{ }7)/16 | 76.05 | 61 | 48 | 86 |
| 2 | 62 | ((5\hat{ }(¼))\hat{ }2)/2 | 193.16 | 62 | 59 | 80 |
| 3 | 63 | (((⅕)\hat{ }(¼))\hat{ }3)*4 | 310.26 | 63 | 70 | 72 |
| 4 | 64 | ((5\hat{ }(¼))\hat{ }4)/4 | 386.31 | 64 | 55 | 31 |
| 5 | 65 | (((⅕)\hat{ }(¼))\hat{ }1)*2 | 503.42 | 65 | 66 | 24 |
| 6 | 66 | ((5\hat{ }(¼))\hat{ }6)/8 | 579.47 | 66 | 50 | 110 |
| 7 | 67 | 5\hat{ }(¼) | 696.58 | 67 | 61 | 104 |
| 8 | 68 | ((5\hat{ }(¼))\hat{ }8)/16 | 772.63 | 68 | 46 | 62 |
| 9 | 69 | ((5\hat{ }(¼))\hat{ }3)/2 | 889.74 | 69 | 57 | 56 |
| 10 | 70 | (((⅕)\hat{ }(¼))\hat{ }2)*4 | 1006.84 | 70 | 68 | 48 |
| 11 | 71 | ((5\hat{ }(¼))\hat{ }5)/4 | 1082.89 | 71 | 53 | 6 |

Table 3 below shows tuning data for 19ET tuning that has been advocated by music theorists such as Joseph Yasser because it is close to ⅓ Comma Meantone tuning, and is associated with historical experimental keyboards. In 19ET, tones (tone) are mathematically defined as increasing fractional n/19 roots of 2, and distances (cents) are shown in increasing steps of about 63.16 cents. From top bottom, the input MIDI Note (key) quickly oversteps the output MIDI Note (nn), such that the distance of one octave on a conventional keyboard spans an octave plus a fifth, and each Pitch Bend LSB (lsb) and Pitch Bend MSB (msb) specifies a pitch unavailable in conventional tuning. This is only one method of programming 19ET; many other key assignment arrangements are possible, including those that omit some tones.

TABLE 3
Tuning Data for 19ET Tuning

| Step | Key | Tone | Cents | nn | lsb | msb |
|---|---|---|---|---|---|---|
| 0 | 60 | 2\hat{ }( 0/19) | 0 | 60 | 64 | 0 |
| 1 | 61 | 2\hat{ }( 1/19) | 63.16 | 61 | 40 | 54 |
| 2 | 62 | 2\hat{ }( 2/19) | 126.32 | 61 | 80 | 108 |
| 3 | 63 | 2\hat{ }( 3/19) | 189.47 | 62 | 57 | 34 |
| 4 | 64 | 2\hat{ }( 4/19) | 252.63 | 63 | 33 | 88 |
| 5 | 65 | 2\hat{ }( 5/19) | 315.79 | 63 | 74 | 13 |
| 6 | 66 | 2\hat{ }( 6/19) | 378.95 | 64 | 50 | 67 |
| 7 | 67 | 2\hat{ }( 7/19) | 442.11 | 64 | 90 | 121 |
| 8 | 68 | 2\hat{ }( 8/19) | 505.26 | 65 | 67 | 47 |
| 9 | 69 | 2\hat{ }( 9/19) | 568.42 | 66 | 43 | 101 |
| 10 | 70 | 2\hat{ }( 10/19) | 631.58 | 66 | 84 | 27 |
| 11 | 71 | 2\hat{ }( 11/19) | 694.74 | 67 | 60 | 81 |
| 12 | 72 | 2\hat{ }( 12/19) | 757.89 | 68 | 37 | 7 |
| 13 | 73 | 2\hat{ }( 13/19) | 821.05 | 68 | 77 | 61 |
| 14 | 74 | 2\hat{ }( 14/19) | 884.21 | 69 | 53 | 115 |
| 15 | 75 | 2\hat{ }( 15/19) | 947.37 | 69 | 94 | 40 |
| 16 | 76 | 2\hat{ }( 16/19) | 1010.53 | 70 | 70 | 94 |
| 17 | 77 | 2\hat{ }( 17/19) | 1073.68 | 71 | 47 | 20 |
| 18 | 78 | 2\hat{ }( 18/19) | 1136.84 | 71 | 87 | 74 |

Table 4 below shows tuning data for 31ET tuning which has been advocated by music theorists such as Christian Huygens and Adriaan Fokker because it is close to ¼ Comma Meantone tuning, and is also associated with historical experimental keyboards. In 31ET, tones (tones) are mathematically defined as increasing fractional n/31 roots of 2, and distances (cents) are shown in increasing steps of about 21.51 cents. From top bottom, the input MIDI Note (key) very quickly oversteps the output MIDI Note (nn), such that the distance of one octave on a conventional keyboard spans two octaves plus a fifth, and each Pitch Bend LSB (lsb) and Pitch Bend MSB (msb) specifies a pitch unavailable in conventional tuning. This is only one method of programming 31ET; many other key assignment arrangements are possible, including those that omit some tones.

TABLE 4
Tuning Data for 31ET Tuning

| Step | Key | Tone | Cents | nn | lsb | msb |
|---|---|---|---|---|---|---|
| 0 | 48 | 2\hat{ }( 0/31) | 0 | 60 | 64 | 0 |
| 1 | 49 | 2\hat{ }( 1/31) | 38.71 | 60 | 88 | 99 |
| 2 | 50 | 2\hat{ }( 2/31) | 77.42 | 61 | 49 | 70 |
| 3 | 51 | 2\hat{ }( 3/31) | 116.13 | 61 | 74 | 41 |
| 4 | 52 | 2\hat{ }( 4/31) | 154.84 | 62 | 35 | 12 |
| 5 | 53 | 2\hat{ }( 5/31) | 193.55 | 62 | 59 | 111 |
| 6 | 54 | 2\hat{ }( 6/31) | 232.29 | 62 | 84 | 83 |
| 7 | 55 | 2\hat{ }( 7/31) | 270.97 | 63 | 45 | 54 |
| 8 | 56 | 2\hat{ }( 8/31) | 309.68 | 63 | 70 | 25 |
| 9 | 57 | 2\hat{ }( 9/31) | 348.39 | 63 | 94 | 124 |
| 10 | 58 | 2\hat{ }( 10/31) | 387.10 | 64 | 55 | 95 |
| 11 | 59 | 2\hat{ }( 11/31) | 425.81 | 64 | 80 | 66 |
| 12 | 60 | 2\hat{ }( 12/31) | 464.52 | 65 | 41 | 37 |
| 13 | 61 | 2\hat{ }( 13/31) | 503.23 | 65 | 66 | 8 |
| 14 | 62 | 2\hat{ }( 14/31) | 541.94 | 65 | 90 | 107 |
| 15 | 63 | 2\hat{ }( 15/31) | 580.65 | 66 | 51 | 78 |
| 16 | 64 | 2\hat{ }( 16/31) | 619.35 | 66 | 76 | 50 |
| 17 | 65 | 2\hat{ }( 17/31) | 658.06 | 67 | 37 | 21 |
| 18 | 66 | 2\hat{ }( 18/31) | 696.77 | 67 | 61 | 120 |
| 19 | 67 | 2\hat{ }( 19/31) | 735.48 | 67 | 86 | 91 |
| 20 | 68 | 2\hat{ }( 20/31) | 774.19 | 68 | 47 | 62 |
| 21 | 69 | 2\hat{ }( 21/31) | 812.90 | 68 | 72 | 33 |
| 22 | 70 | 2\hat{ }( 22/31) | 851.61 | 69 | 33 | 4 |
| 23 | 71 | 2\hat{ }( 23/31) | 890.32 | 69 | 57 | 103 |
| 24 | 72 | 2\hat{ }( 24/31) | 929.03 | 69 | 82 | 74 |
| 25 | 73 | 2\hat{ }( 25/31) | 967.74 | 70 | 43 | 45 |
| 26 | 74 | 2\hat{ }( 26/31) | 1006.45 | 70 | 68 | 17 |
| 27 | 75 | 2\hat{ }( 27/31) | 1045.16 | 70 | 92 | 116 |
| 28 | 76 | 2\hat{ }( 28/31) | 1083.87 | 71 | 53 | 87 |
| 29 | 77 | 2\hat{ }( 29/31) | 1122.58 | 71 | 78 | 58 |
| 30 | 78 | 2\hat{ }( 30/31) | 1161.29 | 72 | 39 | 29 |

Table 5 below shows tuning data for Harry Partch's 43-Tone JI tuning. From top bottom, the output MIDI Note (nn) is shown to span one octave, while the input MIDI Note (key) spans almost four octaves. Each Pitch Bend LSB (lsb) and Pitch Bend MSB (msb) specifies a pitch unavailable in conventional tuning.

TABLE 5
Tuning Data for Harry Partch's 43-Tone Tuning

| Step | Key | Tone | Cents | nn | lsb | msb |
|---|---|---|---|---|---|---|
| 1 | 43 | 1/1 | 0 | 43 | 64 | 0 |
| 2 | 44 | 81/80 | 21.51 | 43 | 77 | 98 |
| 3 | 45 | 33/32 | 53.27 | 44 | 34 | 12 |
| 4 | 46 | 21/20 | 84.47 | 44 | 54 | 8 |
| 5 | 47 | 16/15 | 111.73 | 44 | 71 | 65 |
| 6 | 48 | 12/11 | 150.64 | 45 | 32 | 52 |
| 7 | 49 | 11/10 | 165 | 45 | 41 | 77 |
| 8 | 50 | 10/9 | 182.4 | 45 | 52 | 95 |
| 9 | 51 | 9/8 | 203.91 | 45 | 66 | 64 |
| 10 | 52 | 8/7 | 231.17 | 45 | 83 | 122 |
| 11 | 53 | 7/6 | 266.87 | 46 | 42 | 102 |
| 12 | 54 | 32/27 | 294.14 | 46 | 60 | 32 |
| 13 | 55 | 6/5 | 315.64 | 46 | 74 | 1 |
| 14 | 56 | 11/9 | 347.41 | 46 | 94 | 44 |
| 15 | 57 | 5/4 | 386.31 | 47 | 55 | 31 |
| 16 | 58 | 14/11 | 417.51 | 47 | 75 | 26 |
| 17 | 59 | 9/7 | 435.08 | 47 | 86 | 58 |
| 18 | 60 | 21/16 | 470.78 | 48 | 45 | 38 |
| 19 | 61 | 4/3 | 498.045 | 48 | 62 | 96 |
| 20 | 62 | 27/20 | 519.55 | 48 | 76 | 66 |
| 21 | 63 | 11/8 | 551.32 | 49 | 32 | 108 |
| 22 | 64 | 7/5 | 582.51 | 49 | 52 | 103 |
| 23 | 65 | 10/7 | 617.49 | 49 | 75 | 25 |
| 24 | 66 | 16/11 | 648.68 | 49 | 95 | 20 |
| 25 | 67 | 40/27 | 680.45 | 50 | 51 | 62 |
| 26 | 68 | 3/2 | 701.955 | 50 | 65 | 32 |
| 27 | 69 | 32/21 | 729.22 | 50 | 82 | 90 |
| 28 | 70 | 14/9 | 764.92 | 51 | 41 | 70 |
| 29 | 71 | 11/7 | 782.49 | 51 | 52 | 102 |
| 30 | 72 | 8/5 | 813.69 | 51 | 72 | 97 |
| 31 | 73 | 18/11 | 852.59 | 52 | 33 | 84 |
| 32 | 74 | 5/3 | 884.36 | 52 | 53 | 127 |
| 33 | 75 | 27/16 | 905.87 | 52 | 67 | 96 |
| 34 | 76 | 12/7 | 933.13 | 52 | 85 | 26 |
| 35 | 77 | 7/4 | 968.83 | 53 | 44 | 6 |
| 36 | 78 | 16/9 | 996.09 | 53 | 61 | 64 |
| 37 | 79 | 9/5 | 1017.6 | 53 | 75 | 33 |
| 38 | 80 | 20/11 | 1035 | 53 | 86 | 51 |
| 39 | 81 | 11/6 | 1049.36 | 53 | 95 | 76 |
| 40 | 82 | 15/8 | 1088.27 | 54 | 56 | 63 |
| 41 | 83 | 40/21 | 1115.53 | 54 | 73 | 120 |
| 42 | 84 | 64/33 | 1146.73 | 54 | 93 | 116 |
| 43 | 85 | 160/81 | 1178.49 | 55 | 50 | 30 |

Table 6 below shows tuning data for two consecutive keys in 12ET; this table represents standard tuning data as also shown in (FIG. 26a). Two tones (tone) are mathematically defined as increasing fractional n/12 roots of 2, and the interval distance (cents) between these two tones is shown to be an increase of 100 cents. For both keys, the input MIDI Note (key) is the same as the output MIDI Note (nn), the Pitch Bend LSB (lsb) is the default value of 64, and the Pitch Bend MSB (msb) is a default value of 0. Compare this to the following Table 7 which shows tuning data for twelve consecutive keys in 144ET.

TABLE 6
Tuning Data for Two Consecutive Keys in 12ET Tuning

| Step | Key | Tone | Cents | nn | lsb | msb |
|---|---|---|---|---|---|---|
| 0 | 60 | 2\hat{ }( 0/12) | 0.00 | 60 | 64 | 0 |
| 1 | 61 | 2\hat{ }( 1/12) | 100.00 | 61 | 64 | 0 |

Table 7 shows tuning data for twelve consecutive keys in 144ET. This table represents a six-fold expansion of pitch resources compared to standard tuning as shown in (FIG. 30a). To expand two tones to twelve tones, the standard division of the octave into 12ET may be multiplied by twelve, resulting in 144ET. Twelve tones (tone) are then mathematically defined as increasing fractional n/144 roots of 2, and the interval distance (cents) between each consecutive tone is shown to be an increase of about 8.33 cents. From top bottom, the input MIDI Note (key) quickly oversteps the output MIDI Note (nn), such that the distance of twelve keys on a conventional keyboard now spans what would normally be the distance of two keys in standard tuning, and each Pitch Bend LSB (lsb) and Pitch Bend MSB (msb) in between the first and last key specifies a pitch which is unavailable in conventional tuning

TABLE 7
Tuning Data for Twelve Consecutive Keys in 144ET Tuning

| Step | Key | Tone | Cents | nn | lsb | msb |
|---|---|---|---|---|---|---|
| 0 | 60 | 2\hat{ }( 0/144) | 0 | 60 | 64 | 0 |
| 1 | 61 | 2\hat{ }( 1/144) | 8.33 | 60 | 69 | 43 |
| 2 | 62 | 2\hat{ }( 2/144) | 16.67 | 60 | 74 | 85 |
| 3 | 63 | 2\hat{ }( 3/144) | 25 | 60 | 80 | 0 |
| 4 | 64 | 2\hat{ }( 4/144) | 33.33 | 60 | 85 | 43 |
| 5 | 65 | 2\hat{ }( 5/144) | 41.67 | 60 | 90 | 85 |
| 6 | 66 | 2\hat{ }( 6/144) | 50 | 61 | 32 | 0 |
| 7 | 67 | 2\hat{ }( 7/144) | 58.33 | 61 | 37 | 43 |
| 8 | 68 | 2\hat{ }( 8/144) | 66.67 | 61 | 42 | 85 |
| 9 | 69 | 2\hat{ }( 9/144) | 75 | 61 | 48 | 0 |
| 10 | 70 | 2\hat{ }( 10/144) | 83.33 | 61 | 53 | 43 |
| 11 | 71 | 2\hat{ }( 11/144) | 91.67 | 61 | 58 | 85 |
| 12 | 72 | 2\hat{ }( 12/144) | 100 | 61 | 64 | 0 |

A tuning algorithm requires calculation, and can therefore be more restrictive and more processor intensive than using a tuning data lookup table. The following is an example of a tuning algorithm which maps an incoming note number within an octave divided into 205 equal parts, where n is the note number, f0 is a base frequency and fn is the resulting frequency. Such an algorithm may also require a conversion function to implement fn in a properly formatted digital message to send to a digital musical instrument

$${f}^{n} = {f}^{0} ( \sqrt[\frac{n}{205}]{2} ) \qquad FORMULA 1$$

Some versions of the method further comprise identifying dynamically an available digital output channel to output the modified digital message for producing a microtonal output. This method comprises identifying dynamically an available digital output channel; selecting a digital output channel for the note digital message; sending the digital microtonal note message on the available digital channel.

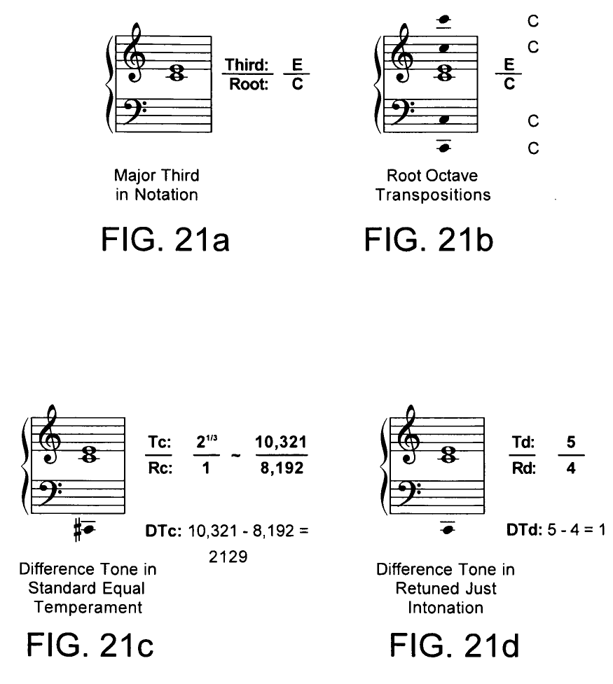

FIG. 21a shows a major third harmonic interval in traditional music notation for two tones, which represent a major third interval spelled with two whole notes from C (Root) up to E (Third). The bottom note (Root) is said to be the more important member of the interval. FIG. 21b shows a root octave transposition in traditional music notation. The notes shown in FIG. 21a may be written at other locations on the staff indicating octave transpositions up or down as shown by the solid note heads in FIG. 21b, such that this figure represents the locations of other notes considered maximally consonant with the notes comprising the given interval.

FIG. 21c shows a an interval in standard tuning (12ET) with difference tone resulting from a major third interval tuned in twelve tone equal temperament, which may produce an undesirable effect and could benefit from retuning. The theoretically correct frequency ratio for an equal tempered major third is 2̂(⅓)/1. So that a comparison may be made between this interval and its retuning, a close approximation is given where the denominator is a power of two, such that the root (Rc) is 8,192 and the third (Tc) is 10,321. The difference tone derived from these frequencies is shown to be 2129 (DTc), which corresponds to tones sounding at nearly one-half step directly above a lower octave transposition, as shown in notation on the staff. Such a sound may be described as unpleasant, giving an impression of incorrectness, incoherence or dissonance.

FIG. 21d shows the difference tone resulting from a major third interval tuned in just intonation and more specifically the combination tones which result from the sounding of the given interval retuned in JI. The frequency ratio for this interval is 5 (Td)/4 (Rd). The difference tone derived from these frequencies is shown to be 1 (DTd), which is said to be the fundamental frequency of a harmonic series which includes both of the harmonic intervals above it. This difference tone sounds exactly at a lower octave transposition, as shown in notation on the staff. Such sounds may be described as pleasant, giving an impression of correctness, coherence or consonance. This is but one example of a retuned interval producing a desirable audible effect.

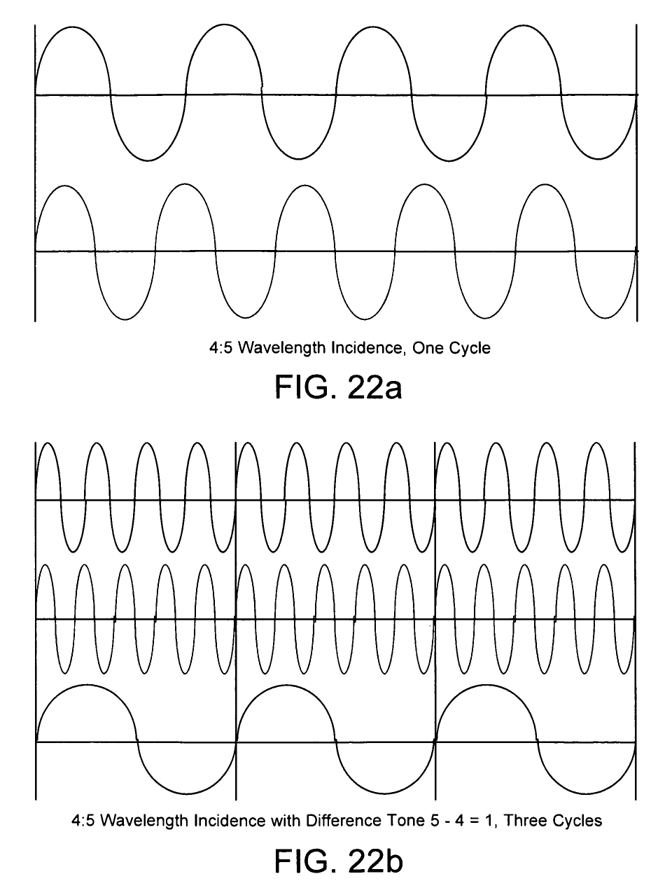

FIG. 22a shows a signal diagram of a one cycle wavelength incidences for two waves in frequency relationship of 4:5, and FIG. 22b shows a signal diagram of three cycles of wavelength incidences for three waves in frequency relationships of 1:4:5. The desirable characteristics of a retuned interval may be further demonstrated in terms of wavelength incidence. Sine wave patterns may be used to represent periodic fluctuations in air pressure above and below normal pressure, where the positive and negative displacement of air molecules is represented by a curve plotted above and below a horizontal line which represents air pressure at equilibrium and also serves as a time axis. Sine wave patterns are shown in (FIGS. 22a-22b) corresponding to the retuned major third interval 5/4 from (FIG. 21d). Two waves can be seen to repeat a pattern representing displacement of air molecules above and below equilibrium four times and five times in the same span of time, beginning in incidence, and ending in incidence with one another, constituting one complete cycle of the two waves (FIG. 22b) shows three complete cycles of the two waves along with wavelength corresponding to the difference tone as shown in (FIG. 21d). Note that small numbers of repetitions are involved in the incidence of all of the waves combined. A similar example showing interval and combination frequencies for the major third in standard 12ET is impossible, because the waves of such an interval are theoretically never at incidence. Even if we used the rational approximation given in (FIG. 21c), the example would require waves which are at incidence only after 10,321 repetitions, which is impractical to show in a drawing

Thus, embodiments of microtonal tuner 75 for a musical instrument using a digital interface are disclosed. One skilled in the art will appreciate that the teachings can be practiced with embodiments other than those disclosed. The disclosed embodiments are presented for purposes of illustration and not limitation, and the invention is only limited by the claims that follow.

What is claimed is:

1. A microtonal tuner for a musical instrument using a digital interface, comprising:
a digital input for a digital message conforming to a digital interface standard;
a digital message analyzer coupled to the digital input to identify a digital message type;
a logic controller coupled to the digital input;
a user input coupled to the logic controller for modifying user controlled parameters;
a user output coupled to the logic controller for communicating microtonal information;
a tuning program containing tuning data coupled to the logic controller to create a modified digital message for producing a microtonal output in real-time that varies in discrete values from a twelve tone equal tempered octave; and,
a digital channel to output the modified digital message for producing a microtonal output.

2. The microtonal tuner as in claim 1 further comprising a synthesizer for receiving the modified digital message on the digital channel to produce an audio output during musical instrument performance.

3. The microtonal tuner as in claim 1 wherein the modified digital message comprises multiple modified digital messages producing multiple microtonal outputs and each microtonal output varies independently in pitch from each other microtonal output.

5. The microtonal tuner as in claim 1 further comprising a digital channel allocator that dynamically routes the modified digital message to an available digital channel.

6. The microtonal tuner as in claim 1 further comprising an analog to digital converter for converting an analog frequency to a note digital message.

7. The microtonal tuner as in claim 1 wherein the tuning data comprises note number and pitch bend data.

8. The microtonal tuner as in claim 1 wherein the tuning program is preprogrammed with a program selected from the group comprising: ¼ Comma Meantone, 19 tone equal temperament, 31 tone equal temperament, Harry Partch's 43-Tone Tuning, and 205 tone equal temperament.

9. The microtonal tuner as in claim 1 wherein the digital input, the digital message, and the digital output are all compatible with a musical instrument digital interface (MIDI).

10. The microtonal tuner as in claim 1 wherein the digital channel is a single digital channel.

11. A microtonal keyboard controller that uses a digital interface, comprising:
a keyboard having keys that generate a digital message corresponding to the key that is operated;
a digital input for the digital message conforming to a digital interface standard;
a digital message analyzer coupled to the digital input to identify a digital message type;
a logic controller coupled to the digital input;
a user input coupled to the logic controller for modifying user controlled parameters;
a user output coupled to the logic controller for communicating microtonal information;
a tuning program containing tuning data coupled to the logic controller to create a modified digital message for producing a microtonal output in real-time that varies in discrete values from a twelve tone equal tempered octave; and,
a channel allocator that dynamically routes the modified digital message to an available digital channel to output the modified digital message for producing a microtonal output.

12. The microtonal tuner as in claim 11 further comprising a synthesizer for receiving the modified digital message on the digital channel to produce an audio output during musical instrument performance.

13. The microtonal tuner as in claim 11 wherein the modified digital message comprises multiple modified digital messages producing multiple microtonal outputs and each microtonal output varies independently in pitch from each other microtonal output.

14. A method for microtonal tuning a musical instrument using a digital interface, comprising:
programming a tuning program with microtonal tuning instructions;
receiving a digital message for a music instruction;
analyzing the digital message to determine the music instruction status;
identifying a note-on music instruction status;
processing the note-on music instruction status through the tuning program;
generating a modified note-on digital message for a microtonal note that varies in a discrete value from a standard twelve equal temperament tuning octave;
selecting a digital output channel for the microtonal note digital message; and,
outputting the modified note-on digital message on the available digital channel to produce a microtonal note that varies in a discrete value from a standard twelve equal temperament tuning octave.

15. The microtonal tuner as in claim 14 further comprising receiving the modified note-on digital message on the available digital channel by a synthesizer to produce an audio output during musical instrument performance.

16. The microtonal tuner as in claim 14 wherein the modified note-on digital message comprises multiple modified note-on digital messages producing multiple microtonal notes and each microtonal note varies independently in pitch from each other microtonal note.

17. The method as in claim 14 further comprising identifying dynamically an available digital output channel to output the modified digital message for producing a microtonal output.

18. The method as in claim 14 wherein the tuning data comprises a tuning table, note number, and pitch bend data.

19. A method for dynamic channel allocation of a microtonal message for a musical instrument using a digital interface, comprising
identifying dynamically an available digital output channel;
selecting a digital output channel for the note digital message; and,
sending the digital microtonal note message on the available digital channel.

20. A computer readable storage medium storing instructions that, when executed by a computer, cause the computer to perform microtonal tuning of a musical instrument using a digital interface, comprising:
programming a tuning program with microtonal tuning instructions;
receiving a digital message for a music instruction;
analyzing the digital message to determine the music instruction status;
identifying a note-on music instruction status;
processing the note-on music instruction status through the tuning program;
generating a modified note-on digital message for a microtonal note that varies in a discrete value from a standard twelve equal temperament tuning octave;
selecting a digital output channel for the microtonal note digital message; and,
outputting the modified note-on digital message on the available digital channel to produce a microtonal note that varies in a discrete value from a standard twelve equal temperament tuning octave.

21. The microtonal tuner as in claim 20 further comprising receiving the modified note-on digital message on the available digital channel by a synthesizer to produce an audio output during musical instrument performance.
